(19) United States
(12) Patent Application Publication
(10) Pub. No.: US 2018/0071743 A1
(43) Pub. Date: Mar. 15, 2018

(54) A WEAR-RESISTANT BODY AND A METHOD FOR PRODUCING THE SAME

(71) Applicant: FLSmidth A/S, Valby (DK)

(72) Inventors: David Dam Olsson, Skodstrup (DK); Bo Sten Christensen, Hadsund Syd (DK)

(21) Appl. No.: 15/559,222

(22) PCT Filed: Mar. 10, 2016
(86) PCT No.: PCT/EP2016/055145

§ 371 Date: Sep. 18, 2017

(30) Foreign Application Priority Data
Mar. 25, 2015 (DK) PA201570172

(51) Int. Cl. B02C 4/30; B02C 15/00

(52) U.S. Cl. CPC B02C 4/305; B02C 2210/02; B02C 15/004; B02C 15/003

(57) ABSTRACT

A wear-resistant body for crushing particulate material in the cement or mineral industries includes a body (1) provided with a plurality of highly wear-resistant inserts (3) embedded in complementary recesses (2) provided in the surface region (6) of the body. A ductile attachment part (4) is arranged within each recess (2), the ductile attachment part (4) being deformable by elastic or plastic deformation and the highly wear-resistant insert (3) being secured in the recess (2) by the ductile attachment part (4) after deformation. In some embodiments the ductile attachment part (4) is in the form of a ring or sleeve. A method for producing such a wear-resistant body is also provided.

### FIELD OF THE INVENTION

The present invention relates to a wear-resistant body and a method for producing a wear-resistant body, for crushing particulate material, such as crude ore, rock, agglomerated material, minerals, stone, material used in the making of cement, minerals and other types of material for use in the cement or mineral industries. The wear-resistant body may for example be used in a vertical roller mill, in a high-pressure roller press, or in similar equipment for crushing particulate material in the mineral or cement industries.

### BACKGROUND TO THE INVENTION

Wear bodies (e.g. rollers and tables) often experience wear as material is crushed by or on the body. For example, as rollers or tables experience wear, portions of the bodies may frequently erode or become broken during use and subsequently require replacement or repair. As a result, such bodies often include a wear surface in an attempt to prolong the life of the body and decrease the frequency of, or need for, replacement or repair.

Some wear surfaces used on wear bodies (e.g. on rollers or tables) include tiles, such as the tiles disclosed in U.S. Pat. No. 5,755,033. In U.S. Pat. No. 5,755,033, a tiled surface is adhered directly to a roller body. The tiles are relatively thin and made of materials harder than the roller body. During use, the tiles can break free from the roller body when crushing material, which may expose the roller body to the grinding process and thereby damage the roller body. The tiles must be reattached or replaced to repair the wear surface and prevent damage to the body. However, because the wear surface is often exposed to grinding forces, the reattachment or replacement of any missing tile may result in a less secure attachment than what was initially provided, which may make the tile more likely to again break free during use.

Other wear surfaces may include wear-resistant inserts that are attached directly to a wear body (e.g. a roller or table). A wear-resistant insert may be attached to a roller body or table by glue or an adhesive or explosion welding. Rollers or tables with such wear surfaces often experience insert cracking, breaking or fall out because the glue, adhesive or welding fails to provide a sufficient bond with a wear body or wear surface to withstand the extreme pressures associated with grinding and crushing material.

Other wear surfaces used in crushing devices may be appreciated from U.S. Pat. No. 5,269,477. Such wear surfaces include wear-resistant inserts embedded in recesses. A binding ring may be used to attach the wear-resistant inserts to the wear surfaces of the roller body. However, once the relatively thin binding rings of such surfaces are depleted due to wear, the inserts are no longer mechanically retained within the roller body during use so that a bond provided by glue or other adhesive may be the only means of retaining the inserts within the roller body. As a result, the inserts may fall out or become damaged. Replacement of such inserts may be very time consuming if binding rings are again used to reattach the new inserts. In addition, the use of glue or other adhesive as an attachment mechanism requires significant costs. With glue or adhesive, longer wear-resistant inserts are required for proper retention. This is because a length (I) to diameter (d) ratio for the inserts is required to be more than two. This implies that additional wear resistant material (which is expensive) is required in order to manufacture the wear-resistant inserts.

European patent 0516952 B1 describes another wear surface in which the wear bodies comprise a plurality of cylindrical inserts embedded in the crushing surface. The cylindrical inserts, which are made of wear-resistant material, are inserted in drilled holes or recesses in the wear surface of the wear body (roller) and secured by means of a shrink fit connection or a similar arrangement. Part of the inserts protrudes from the surface of the roller. Given that the inserts and recesses must fit each other exactly in order to withstand the high loads occurring during operation they must be manufactured with a relatively high degree of precision and since the entire circumference of the roller is covered with inserts it is a very time-consuming process to manufacture such a roller. As a consequence thereof, the manufacture of such rollers involves significant costs. It would be preferable to have less requirements to the precision of the recesses and the inserts.

US Patent Publication Number 2014/0183291 describes a wear surface in which wear inserts are embedded in sleeves in recesses. However, such an arrangement is not preferable because it requires that the sleeves be manufactured to fit precisely within the recesses. Thereafter, it is the surface material of the roller surface which locks the wear inserts into place in the recesses.

Other methods of attaching inserts into wear surfaces and wear bodies, such as screwing, or using a circlip are known. However, these methods imply a complex thus expensive machining of the wear surface and body. Because the number of wear-resistant inserts on a typical roller or table is several hundred this would result in long machining times like making threads or precision drilling which would result in high machining costs. Using circlip or locking rings require special sloths which increase cost due to machining. Furthermore, it is expected with the aforementioned methods that the attachment is more complex which is not suited for on-site applications.

It is an object of the present invention to provide a wear-resistant body by means of which the described disadvantages are eliminated or reduced.

A new wear-resistant body (and a method for producing the same) is needed that may incorporate a more stable and reliable means of attachment, support and retention of wear-resistant inserts. Embodiments of the wear-resistant body preferably permit sufficient attachment of the wear-resistant inserts to e.g. a roller or table to increase the stability and life of the body. The inserts are preferably secured sufficiently to significantly reduce, if not completely reduce, the occurrences of insert breakage or other insert damage, which can help reduce maintenance costs and downtime for crushing devices that use embodiments of the wear-resistant body.

### SUMMARY OF INVENTION

A wear-resistant body for crushing particulate material, such as crude ore for use in the cement or mineral industries, and a method for making such a wear-resistant body are provided herein. The wear-resistant body includes a body provided with a plurality of highly wear-resistant inserts embedded in complementary recesses provided in the surface region of the body. A ductile attachment part is arranged within each recess. The ductile attachment part is deformable by elastic or plastic deformation and the highly wear-resistant insert is secured in the recess by the ductile attachment part after deformation.

In an exemplary embodiment the wear-resistant body is a roller table segment or a roller.

In an exemplary embodiment the ductile attachment part is in the form of a ring or sleeve. The inner surface of the ductile attachment part may be e.g. tapered, double tapered, jagged, circular, have chamfered edges, recess shaped, grooved, threaded or mushroom shaped.

The inner surface of the ductile attachment part in one of the recesses may be tapered and the outer surface of at least one of the highly wear-resistant inserts in the same recess may be correspondingly tapered to fit into the ductile attachment part. The inner surface of the ductile attachment part in one of the recesses may be jagged and the outer surface of at least one of the highly wear-resistant inserts in the same recess may be correspondingly jagged to fit into the ductile attachment part. The inner surface of the ductile attachment part in one of the recesses may be double tapered, circular, have chamfered edges, recess shaped, grooved, threaded or mushroom shaped and the outer surface of at least one of the highly wear-resistant inserts in the same recess may be correspondingly double tapered, circular, have chamfered edges, recess shaped, grooved, threaded or mushroom shaped to fit into the ductile attachment part.

In an exemplary embodiment the ductile attachment part mainly comprises aluminium. In another embodiment the ductile attachment part comprises steel.

In another embodiment the ductile attachment part is an alloy. In an exemplary embodiment the highly wear-resistant insert comprises a composite material, cemented tungsten carbide, tool steel fabricated by metal matrix composite (“MMC”) or ceramic. In one embodiment the plurality of recesses have an engineering tolerance of greater than or equal to 0.3 mm. In one embodiment the surface region of the body has a Vickers hardness of between 170 HV and 260 HV, the ductile attachment parts have a Vickers hardness of less than 80 HV and the highly wear-resistant inserts have a Vickers hardness of greater than 600 HV. In one embodiment the surface region of the body has a yield stress of between 550 MPa and 800 MPa and the ductile attachment part has yield stress of less than 250 MPa.

In yet another exemplary embodiment, the highly wear-resistant insert may comprise at least one section, in the axial direction of the insert, the at least one section overlapping at least a portion of a surface of an upper region of the ductile attachment part and the at least one section protruding from the recess. In some embodiments, at least a portion of an upper region of the ductile attachment part may protrude from the recess.

Autogenous or semi-autogenous material may be arranged on a surface region of the body between the recesses so that the highly wear-resistant insert is further secured in the recess by the autogenous or semi-autogenous material.

A method of producing a wear-resistant body as described herein for crushing particulate material, such as crude ore for use in the cement or mineral industries is also provided. The method comprises the steps of: providing a surface region of the body with a plurality of recesses, embedding into each of the recesses a ductile attachment part, embedding into each of the recesses a highly wear-resistant insert, compressing and deforming the ductile attachment part after embedding the wear-resistant insert and the ductile attachment part in the recess by application of a compressing force to the ductile attachment part thereby securing the highly wear-resistant insert within each recess and to the body.

The compressing force may be applied to the ductile attachment part by applying a compressing force directly to the highly wear-resistant insert. The compressing force may also be applied directly to the ductile attachment part. The compressing force may be applied by an impact or pressing tool. The ductile attachment part and the highly wear-resistant insert may be joined or preassembled outside of the recess before embedding the ductile attachment part and the highly wear-resistant insert into the recess.

The method may further comprise a step of providing an autogenous or semi-autogenous material to the surface region of the body between the highly wear-resistant inserts. The method may further comprise a step of removing a worn or broken highly wear-resistant insert from its recess before embedding a new highly wear-resistant insert into the same recess.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of wear-resistant bodies, devices configured for the comminution of material that utilize one or more embodiments of the wear-resistant bodies and methods of making the same are shown in the accompanying drawings. It should be understood that like reference numbers used in the drawings may identify like components.

FIG. 1 is a perspective view of a vertical mill which may embody wear-resistant bodies (i.e.—rollers or tables) of the present invention.

FIG. 2 is a perspective view of a high-pressure grinding mill which may embody wear-resistant bodies (i.e.—rollers) of the present invention.

FIG. 3 is a perspective view of a wear-resistant roller body illustrating the recesses and the surface region of the roller body.

FIG. 4 is an exploded view of a wear-resistant roller body segment illustrating the recesses and the surface region of the roller body.

FIGS. 5A-5E are perspective views of highly wear-resistant inserts according to different embodiments of the invention.

FIGS. 6A-6E are perspective views of highly wear-resistant inserts and corresponding ductile attachment parts according to different embodiments of the invention.

FIG. 7 is a fragmentary cross sectional view of a portion of an embodiment of the wear-resistant roller body that illustrates highly wear-resistant inserts and the corresponding ductile attachments parts in the recesses of the roller.

FIGS. 8A-8C are fragmentary cross sectional views of portions of different embodiments of the wear-resistant roller body which illustrate highly wear-resistant inserts and the corresponding ductile attachments parts in the recesses of the roller body.

FIG. 9A is a fragmentary cross sectional exploded view of a portion of an embodiment of the wear-resistant roller body which illustrates a highly wear-resistant insert and the corresponding ductile attachment part.

FIG. 9B is a fragmentary cross sectional view of a portion of an embodiment of the wear-resistant roller body which illustrates a highly wear-resistant insert and the corresponding ductile attachment parts in a recess of the roller body.

### DETAILED DESCRIPTION OF PRESENT PREFERRED EMBODIMENTS

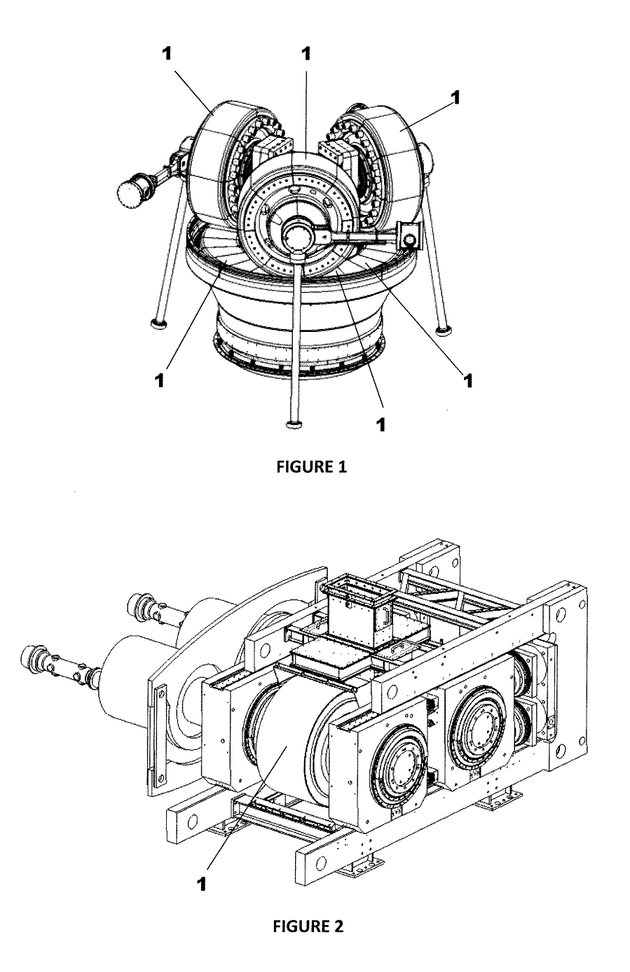

The present invention relates to a wear-resistant body 1, and a method for producing a wear-resistant body 1, for crushing particulate material, such as crude ore, rock, agglomerated material, minerals, stone, material used in the making of cement, minerals and other types of material for use in the cement or mineral industries. The wear-resistant body 1 may for example be used in a vertical roller mill (as shown in FIG. 1), a high-pressure grinding roller press (typically known as an “HPGR”) (as shown in FIG. 2), or in similar equipment for crushing particulate material in the mineral or cement industries.

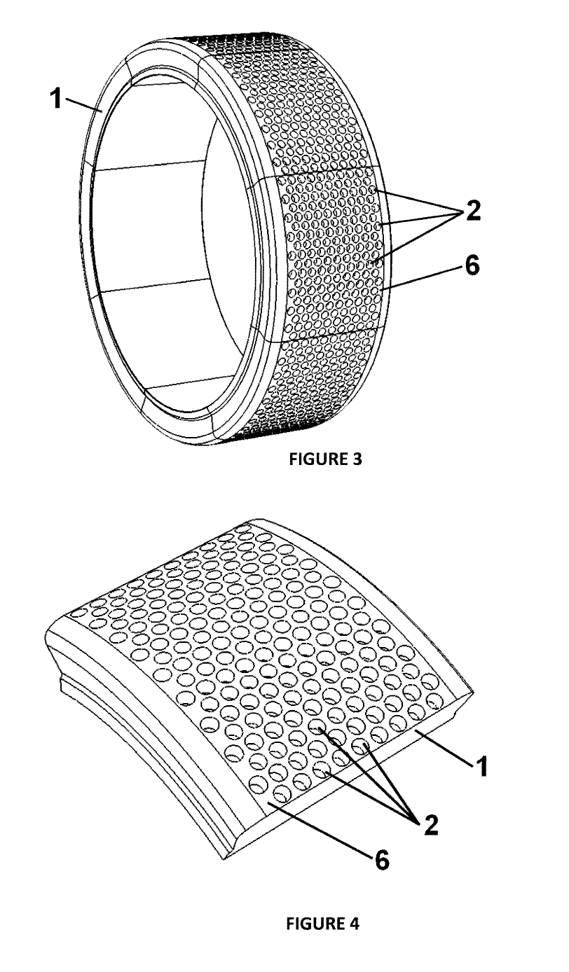

FIGS. 3 and 4 show a wear-resistant body 1 in the form of a roller body, and a section thereof (FIG. 4), with recesses 2 embedded in the surface region 6 of body 1. While a certain number of recesses 2 are shown, there can be more or less recesses embedded in the surface region 6 of the body 1. Additionally, the recesses 2 shown in FIGS. 3 and 4 are substantially circular in shape. However, in different embodiments of the invention other shapes of the recesses 2 are applicable. The recesses 2 are manufactured to correspond to the shape of the wear-resistant inserts 3.

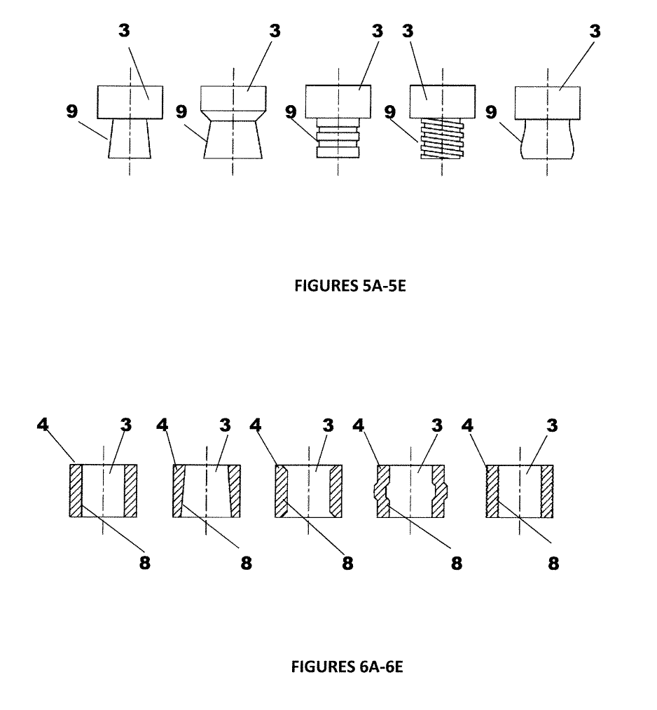

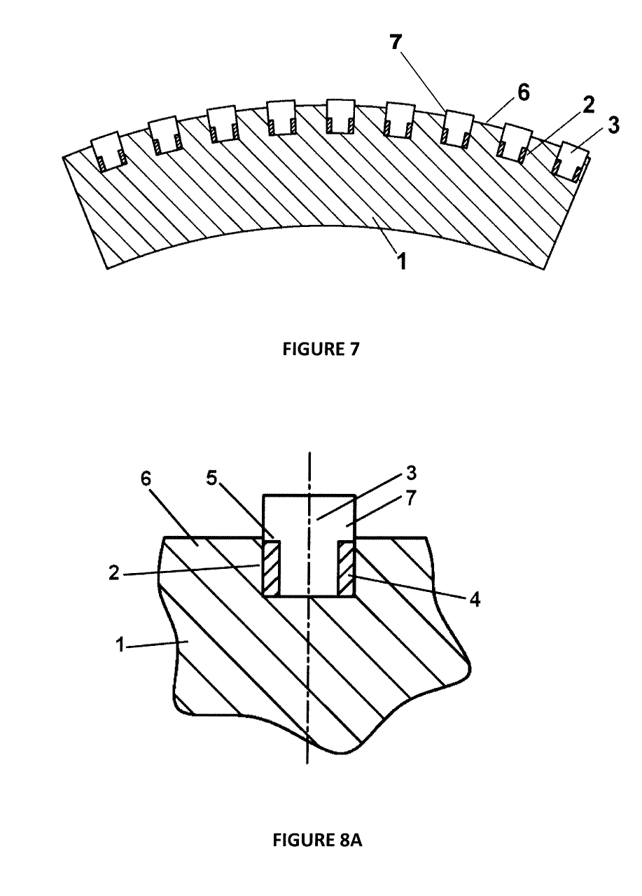

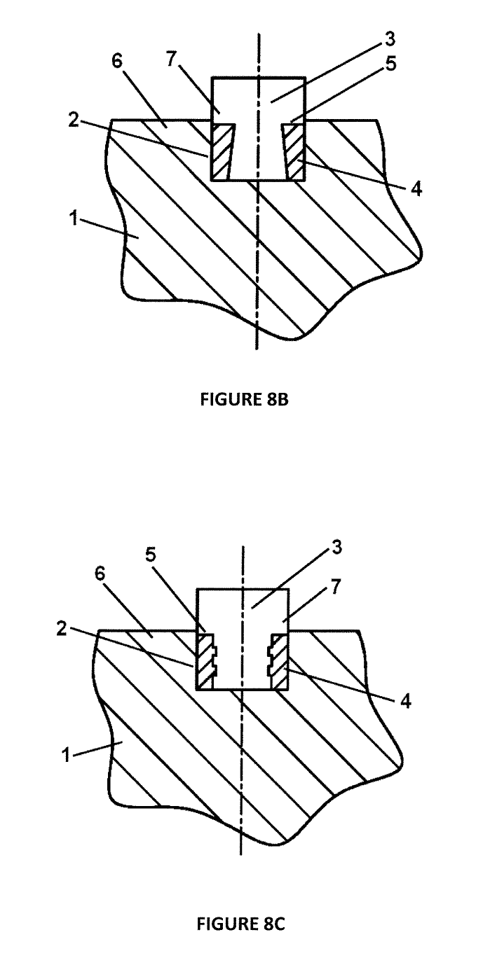

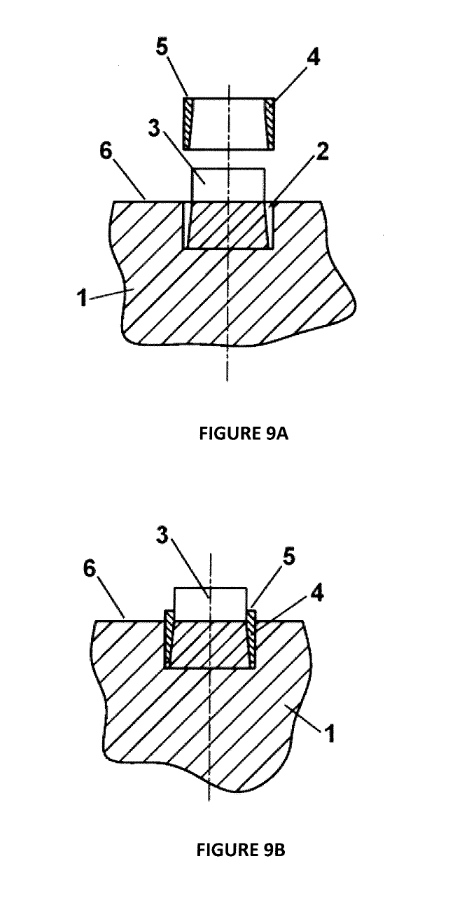

FIGS. 5A through 5E show various shapes of the highly wear-resistant inserts 3. Only the main geometry of the highly wear-resistant inserts 3 is shown. Outer surfaces 9 of the highly wear-resistant insert 3 which are tapered, double tapered, grooved, threaded and curved (mushroom shaped) are shown, but other shapes are also applicable e.g. circular highly wear-resistant inserts 3 (see e.g. FIGS. 7 and 8A) and the shapes depicted in e.g. FIGS. 6A-6E, 8A-8C and 9A-9B. The optimal geometry of the outer surfaces 9 of the highly wear-resistant inserts 3 will e.g. be dependent on the material to be processed, the shape of the ductile attachment parts 4 and the force exerted on the body 1. The recesses 2 are manufactured to correspond to the shape of the highly wear-resistant inserts 3.

In different embodiments the highly wear-resistant inserts 3 may comprise cemented tungsten carbide, tool steel fabricated by a metal matrix composite (“MMC”), ceramics or a composite material.

FIGS. 6A through 6E show various shapes of the ductile attachment parts 4 and the corresponding shape of the wear-resistant inserts 3 inserted therein. The ductile attachment part 4 can be in the shape of a ring or sleeve (as shown in FIGS. 9A-9B). In other embodiments, the ductile attachment part 4 is not ring shaped and can be a wafer, a sphere or other amorphous shapes. Circular, tapered, a chamfered edge ductile attachment part 4, a recess shaped with grooved inner 8 and outer surfaces and a grooved ductile attachment part 4 are shown, but other shapes are applicable. The optimal geometry of the ductile attachment parts 4 will e.g. be dependent on the material to be processed, the shape of the highly wear-resistant inserts 3 and the force exerted on the body 1. The recesses 2 are manufactured to correspond to the shape of the highly wear-resistant inserts 3 and the ductile attachment parts 4.

In different embodiments the ductile attachment part 4 may mainly comprise aluminium or be completely comprised of aluminium which are deformable by elastic or plastic deformation. In other embodiments, the ductile attachment part 4 may comprise less ductile materials such as steel and other like materials which are deformable by elastic or plastic deformation. The ductile attachment part may also be an alloy. In a preferred embodiment, the ductile attachment part 4 mainly comprises aluminium due to the deformation-hardening effect and ease of deformation.

In a preferred embodiment the surface 6 has a Vickers hardness range of between 170 and 260 HV, the ductile attachment part 4 has a Vickers hardness range of less than 80 HV and the highly wear-resistant insert 3 has a Vickers hardness range of greater than 600 HV. In a preferred embodiment the surface 6 has a yield stress range of between 550 and 800 MPa and the ductile attachment part 4 has a yield stress range of less than 250 MPa.

FIG. 7 shows a fragmentary cross-sectional view of a portion of an embodiment of the body 1 that illustrates multiple highly wear-resistant inserts 3 and the corresponding ductile attachments parts 2 in the recesses 2 of the body 1. The ductile attachment part 4 is arranged within each recess 2, the ductile attachment part 4 being deformable by plastic or elastic deformation and the highly wear-resistant insert 3 is secured in the recess 2 by the ductile attachment part 4 after deformation. An autogenous or semi-autogenous material (not shown) can be provided to the surface region 6 of the body 1 between the highly wear-resistant inserts 3. The autogenous or semi-autogenous material (not shown) can further secure the highly wear-resistant inserts 3 in the recesses 2. The autogenous or semi-autogenous material (not shown) can also provide additional wear-protection to the surface of the body.

FIGS. 8A-8C show fragmentary cross sectional views of portions of different embodiments of the wear-resistant body 1 which illustrate highly wear-resistant inserts 3 and the corresponding ductile attachments parts 4 in the recesses 2 of the body 1. As shown in FIG. 8A, in one embodiment the inner surface 8 of the ductile attachment part 4 in one of the recesses 2 is circular and the outer surface 9 of the highly wear-resistant insert 3 in the same recess 2 is correspondingly circular to fit into the ductile attachment part 4. In some embodiments, as shown in FIGS. 8A-8C, the highly wear-resistant insert 3 comprises at least one section 7, in the axial direction of the insert, where the at least one section 7 overlaps at least a portion of a surface of an upper region 5 of the ductile attachment part 4 and the at least one section 7 protrudes from the recess 2. Such an arrangement provides for a higher tolerance to lateral forces as the wear-resistant inserts 3 overlap with the recesses 2.

As shown in FIG. 8B, in one embodiment the inner surface 8 of the ductile attachment part 4 in one of the recesses 2 is tapered and the outer surface 9 of the highly wear-resistant insert 3 in the same recess 2 is correspondingly tapered to fit into the ductile attachment part 4. As shown in FIG. 8C, in one embodiment the inner surface 8 of the ductile attachment part 4 in one of the recesses 2 is grooved and the outer surface 9 of the highly wear-resistant insert 3 in the same recess 2 is correspondingly grooved to fit into the ductile attachment part 4. In other embodiments (not shown) the ductile attachment part 4 in one of the recesses 2 is shaped (as shown in e.g. FIGS. 6A-6E, 7, 9A-9B) and the outer surface 9 of the highly wear-resistant insert 3 in the same recess 2 is correspondingly shaped to fit into the ductile attachment part 4 (as shown in e.g. FIGS. 5A-5E, 6A-6E, 7, 9A-9B).

As shown in FIG. 9B, in another embodiment the inner surface 8 of a ductile attachment part 4 in one of the recesses 2 is reverse-tapered and the outer surface 9 of the highly wear-resistant insert 3 in the same recess 2 is correspondingly tapered to fit into the ductile attachment part 4. In some embodiments, as shown in FIG. 9B, the highly wear-resistant insert 3 comprises at least one section 7, in the axial direction of the insert, where the at least one section 7 does not overlap at least a portion of a surface of an upper region 5 of the ductile attachment part 4. In some embodiments the at least one section 7 and an upper region 5 of the ductile attachment part 4 protrudes from the recess 2. In one embodiment, the ductile attachment part 4 comprises steel and is deformable by elastic deformation meaning that it will return to its initial shape when it is relaxed. Such an elastically deformable ductile attachment part 4 is preferable when repairing broken or damaged highly wear-resistant insert 3.

FIG. 9A shows the highly wear-resistant insert 3 in the recess 2 and the correspondingly shaped ductile attachment part 4 before the ductile attachment part 4 is embedded into the recess 2 and before compressing and deforming the ductile attachment part 4 to secure the highly wear-resistant insert 3 within each recess 2 and to the body 1.

The present invention provides a solution by which wear-resistant inserts 3 are attached without adhesive or welding and whereby the tolerance between the wear-resistant inserts 3 and the pre-machined recesses 2 is 0.3 mm or greater. Unlike prior art solutions which require tight tolerances, the present invention eliminates the need for such tight tolerances and thereby eliminates problems when shifting from one supplier to another as each supplier typically uses separate dies for compressing the wear-resistant inserts during manufacturing which can result in slightly smaller or larger wear-resistant inserts. The increased tolerance requirement also allows for the recesses to be produced using high speed drilling tools which can lower the production time of drilling the recesses into the body as compared to the more time consuming precision drilled holes which were necessary with prior art solutions.

Additional advantages of the present invention include e.g:
full retention of highly wear-resistant inserts at elevated ambient temperatures (greater than 400 degrees Celcius);
the highly wear-resistant inserts have a significantly larger retention force as compared to prior art solutions for attaching wear-resistant inserts;
compressive loads during operation of roller machines are beneficial for further attachment of the highly wear-resistant inserts (whereas inserts secured by glue or other adhesives typically become loose due to breakage of the adhesive layers as a result of the relative motion of the adhered inserts);
the attachment method provided herein allows for shorter highly wear-resistant inserts to be applied resulting in a significant lower costs (i.e. in the present invention a length to diameter ratio of close to 1 can be achieved);
the attached highly wear-resistant inserts, in the axial direction, can withstand severe lateral impacts as the ductile attachment part hardens quickly by elastic or plastic deformation;
the method provided herein allows for large tolerances of the recesses where the higher deviation of highly wear-resistant insert tolerances can be accepted as these tolerances are taken up by deformation of the mating ductile attachment part;
the higher tolerances allow for an increase of drill speed and thus reduce overall machining time;
the attachment method requires no heat treatment, no adhesive and no welding and thus any advanced process equipment implying that this solution can be implemented in-situ in the field; and
the highly wear-resistant inserts may be produced as composites in order to save tungsten-carbide and thus significantly reduce costs.

A method of producing a wear-resistant body 1 as shown in e.g. FIGS. 3-9 is also contemplated herein. Such a method may produce a wear-resistant body 1 that may for example be used in a vertical roller mill (as shown in FIG. 1), a HPGR (as shown in FIG. 2), or in similar equipment for crushing particulate material in the mineral or cement industries. The method may comprise the steps of providing a surface region 6 of a wear-resistant body 1 with a plurality of recesses 2, embedding into each of the recesses 2 a ductile attachment part 4, embedding into each of the recesses 2 a highly wear-resistant insert 3 and compressing and deforming the ductile attachment part 4 after embedding the highly wear-resistant insert 3 and the ductile attachment part 4 in the recess 2 by application of a compressing force to the ductile attachment part 4 thereby securing the highly wear-resistant insert 3 within each recess 2 and to the roller 1. In other embodiments of the method, the method may also include a step of providing an autogenous or semi-autogenous material to the surface region 6 of the body 1 between the highly wear-resistant inserts 3. In some embodiments of the method, the method may also include removing a worn or broken highly wear-resistant insert 3 from its recess 2 before embedding a new highly wear-resistant insert 3 into the same recess 2.

In some embodiments of the method, the ductile attachment part 4 and the highly wear-resistant insert 3 are joined or preassembled outside of the recess 2 before embedding the ductile attachment part 4 and the highly wear-resistant insert 3 into the recess 2.

In some embodiments of the method the compressing force is applied to the ductile attachment part 4 by applying a compressing force directly to the wear-resistant insert 3. In other embodiments, the compressing force may be applied directly to the ductile attachment part 4. In some embodiments the compressing force is applied by an impact or pressing tool.

Various changes may be made in the function and arrangement of parts; equivalent means may be substituted for those illustrated and described; and certain features may be used independently from others without departing from the spirit and scope of the invention as defined in the following claims.

1. A wear-resistant body for crushing particulate material for use in the cement or mineral industries, comprising a body provided with a plurality of highly wear-resistant inserts embedded in complementary recesses provided in the surface region of the body wherein a ductile attachment part is arranged within each recess, the ductile attachment part being deformable by plastic or elastic deformation and the highly wear-resistant insert being secured in the recess by the ductile attachment part (4) after deformation.

2. The wear-resistant body of claim 1, wherein the ductile attachment part is in the form of a ring or sleeve.

3. The wear-resistant body of claim 1, wherein an inner surface of the ductile attachment part (4) is tapered or jagged.

4. The wear-resistant body of claim 1, wherein the surface region of the body has a vickers hardness of between 170 HV and 260 HV, the ductile attachment part has a vickers hardness of less than 80 HV and the highly wear-resistant inserts have a vickers hardness of greater than 600 HV.

5. The wear-resistant body of claim 1, wherein the surface region of the body has a yield stress of between 550 MPa and 800 MPa and the ductile attachment part has yield stress of less than 250 MPa.

6. The wear-resistant body of claim 1, wherein a tolerance between the highly wear-resistant inserts and the recesses is at least 0.3 mm.

7. A method of producing the wear-resistant body of claim 1, the method comprising the steps of:
providing a surface region of the wear-resistant body with a plurality of recesses
embedding into each of the recesses a ductile attachment part
embedding into each of the recesses a highly wear-resistant insert
compressing and deforming the ductile attachment part after embedding the wear-resistant insert and the ductile attachment part in the recess by application of a compressing force to the ductile attachment part thereby securing the highly wear-resistant insert within each recess and to the body.

8. The method of producing a wear-resistant body according to claim 7 further comprising a step of providing an autogenous or semi-autogenous material to the surface region of the body between the highly wear-resistant inserts.

9. The method of producing a wear-resistant body according to claim 7, wherein the compressing force is applied to the ductile attachment part by applying the compressing force directly to the wear-resistant insert.

10. The method of producing a wear-resistant body according to claim 7, further comprising a step of removing a worn or broken highly wear-resistant insert from its recess before embedding a new highly wear-resistant insert into the same recess.
